(19) United States
(12) Patent Application Publication
(10) Pub. No.: US 2006/0046231 A1
(43) Pub. Date: Mar. 2, 2006

(54) Learning machine for automatic word recognition based on a carbon pattern

(76) Inventor: Hong-Tien Lin, Pa-Te Ctiy (TW)

Correspondence Address: HERSHKOVITZ & ASSOCIATES, 1725 I STREET NW, SUITE 300, WASHINGTON, DC, 20006, US

(21) Appl. No.: 10/898,988

(22) Filed: Jul. 27, 2004

(51) Int. Cl. G09B 17/00

(52) U.S. Cl. 434/169; 434/178

(57) ABSTRACT

A learning machine for automatic word recognition is based on a carbon pattern on a card. One face of the card is printed with a letter while the other face has a specified carbon pattern, thus every letter is distributed an exclusive carbon pattern. When the card is placed on a sensing slot, the letter will be recognized by the learning machine; similarly, a word consisting of some of those letters will also be recognized.

### BACKGROUND OF THE INVENTION

1. Field of the Invention

The present invention relates to a learning machine for automatic word recognition based on a carbon pattern, and particularly relates to a learning machine that can recognize a letter in an alphabet or a word based on a predetermined carbon pattern.

2. Description of Related Art

At present, foreign language learning methods often include: direct communication with teachers and applying teaching materials such as tapes, paper material, or multimedia material. However, learners are in a passive status in most of the above methods, and this fails to achieve a satisfactory result, especially with younger children. In other words, if the learning method could provide responses corresponding to an answer, a sense of fulfillment will be obtained to increase an appetite for learning.

Therefore, the invention provides a learning machine for automatic word recognition based on a carbon pattern to mitigate or obviate the aforementioned problem.

### SUMMARY OF THE INVENTION

The main objective of the present invention is to provide a learning machine for automatic word recognition based on a carbon pattern. Every letter in an alphabet is exclusively predetermined as a kind of carbon pattern, so the learning machine can recognize each letter in the alphabet as well as a word consisting of some of those letters, and further pronounce the word.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view in accordance with this invention;

FIG. 2 is a perspective view in accordance with this invention;

FIG. 3A-3C are back views of multiple cards in accordance with this invention;

FIGS. 4A-4E is a circuit diagram showing a control module in accordance with this invention;

FIGS. 5A-5C is a circuit diagram showing a scan module in accordance with this invention;

FIGS. 6A-6B is a circuit diagram showing a sensing module in accordance with this invention;

FIG. 7 is an operation illustration of a first embodiment in accordance with this invention; and

FIG. 8 is an operation illustration of another embodiment in accordance with this invention.

### DETAILED DESCRIPTION OF THE PREFERRED EMBODIMENT

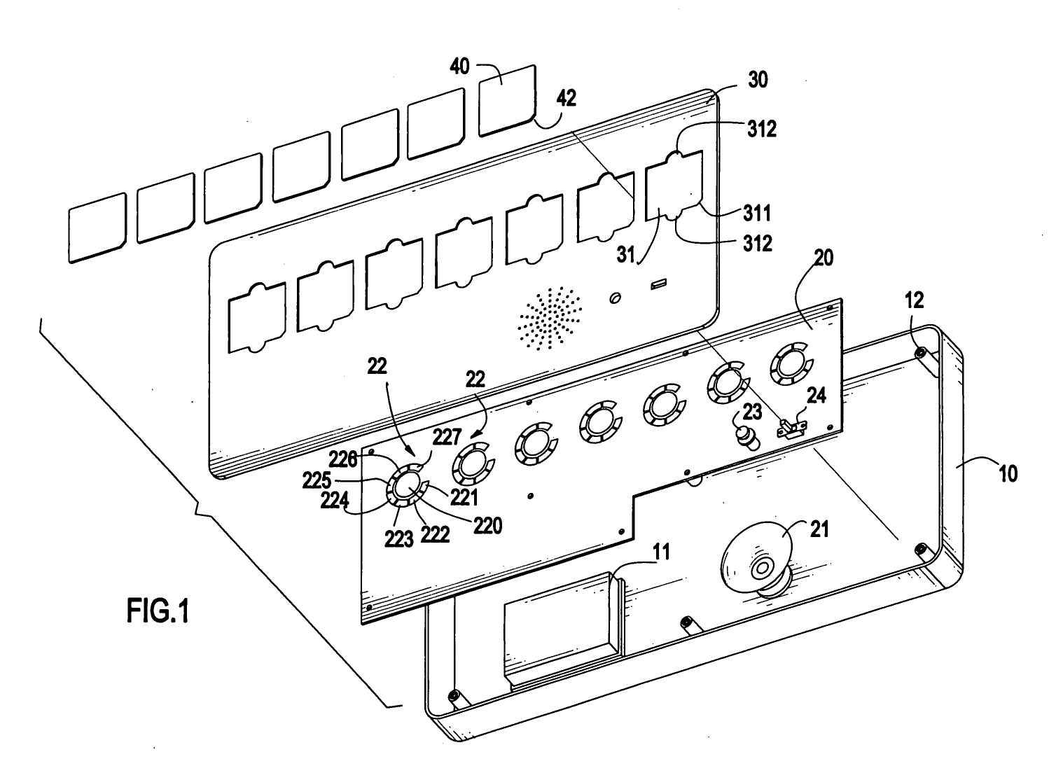

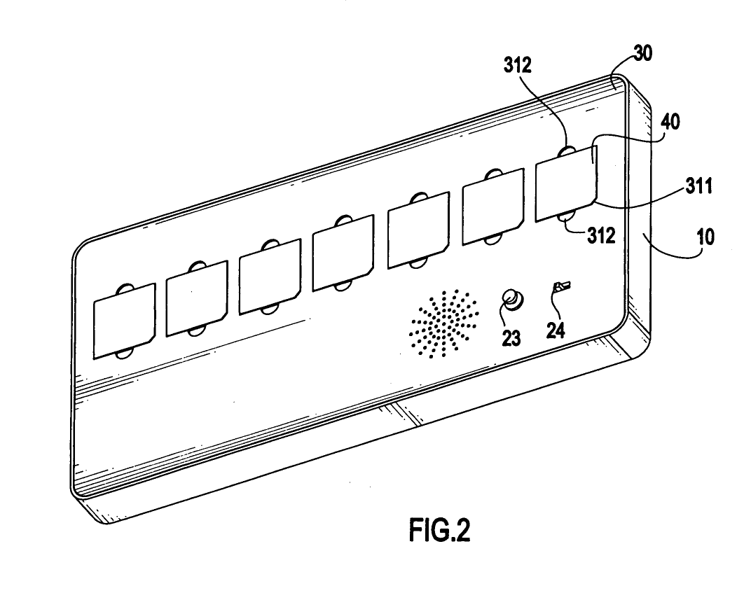

With reference to FIGS. 1-2, a learning machine for automatic word recognition based on a carbon pattern has a housing (10) having a rectangular chamber (not numbered) defined therein; a cell box (11) and a speaker (21) are installed in the chamber; A plurality of poles (12) each with a threaded hole (not numbered) is mounted at sides and comers of the chamber of the housing.

An integrated circuit board (20) is mounted in the housing (10), and has a plurality of openings in edges thereof, so the integrated circuit can be mounted by screws or bolts (not shown) engaged in the poles (12) in the housing (10). A surface of the integrated circuit board (20) has multiple sensing units (22) made of carbon formed thereon by printing and each sensing unit (22) includes a frequency emitting point (220) as well as multiple frequency receiving points (221)-(227); a voice key (23); and a letter/word switch key (24).

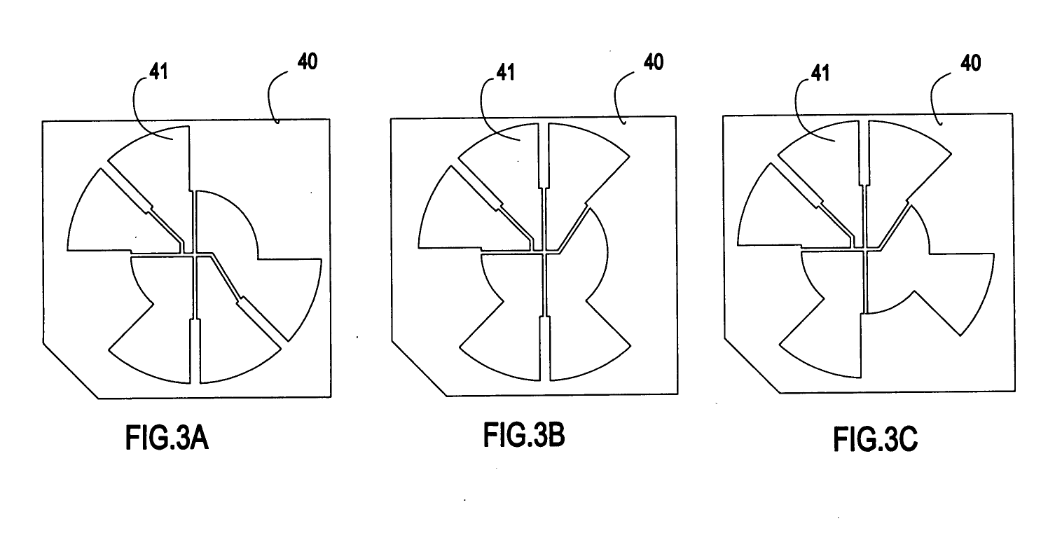

A panel (30) is installed on the housing (10), so the integrated circuit board (20) with other components are kept in the housing (10), and multiple sensing slots (31) are defined through the panel (30) each with an upper edge and a lower edge. Multiple cards (40) are respectively received in the sensing slots (31). Each sensing slot (31) has a first chamfer (311), and the card (40) has a second chamfer (42) corresponding to the first chamfer (311), so the card can be correctly received in the sensing slot (31). Two notches (312) are defined in the upper edge and the lower edge respectively, which facilitate removing the card (40). Each card is printed with a letter on the front face, and the back face is shown in FIG. 3 (A)-(C). The back face of each card consists of eight radiating areas, wherein seven areas can be optionally printed with carbon according to the requirement, so different carbon area combinations can be classified into 2⁷=128 carbon patterns. If a foreign language is English with 26 letters, thus each letter will be distributed a specified carbon pattern. Therefore, every letter can be recognized based on its specified carbon pattern and a word consisting of some of those letters can also be recognized by those specified card (40) combinations.

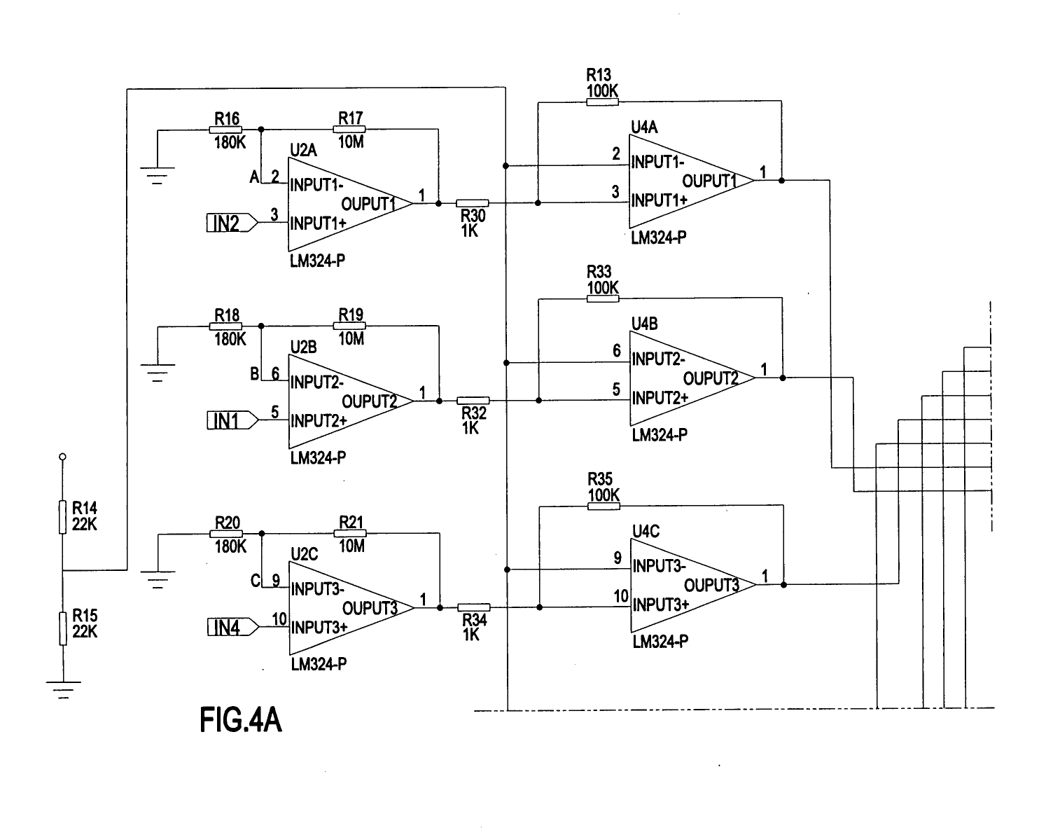

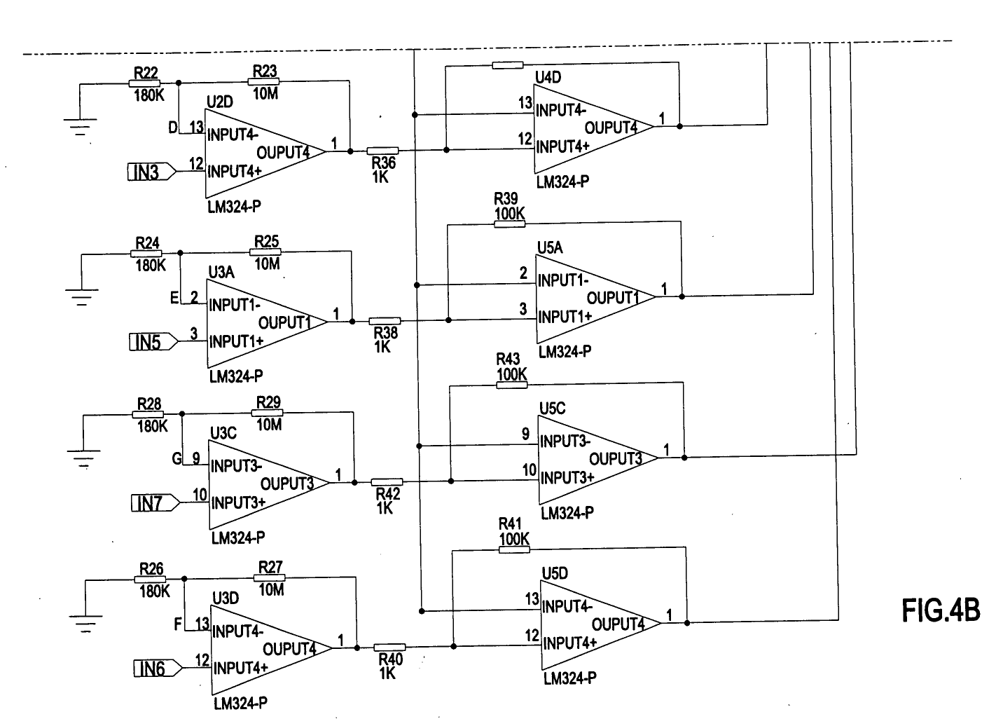

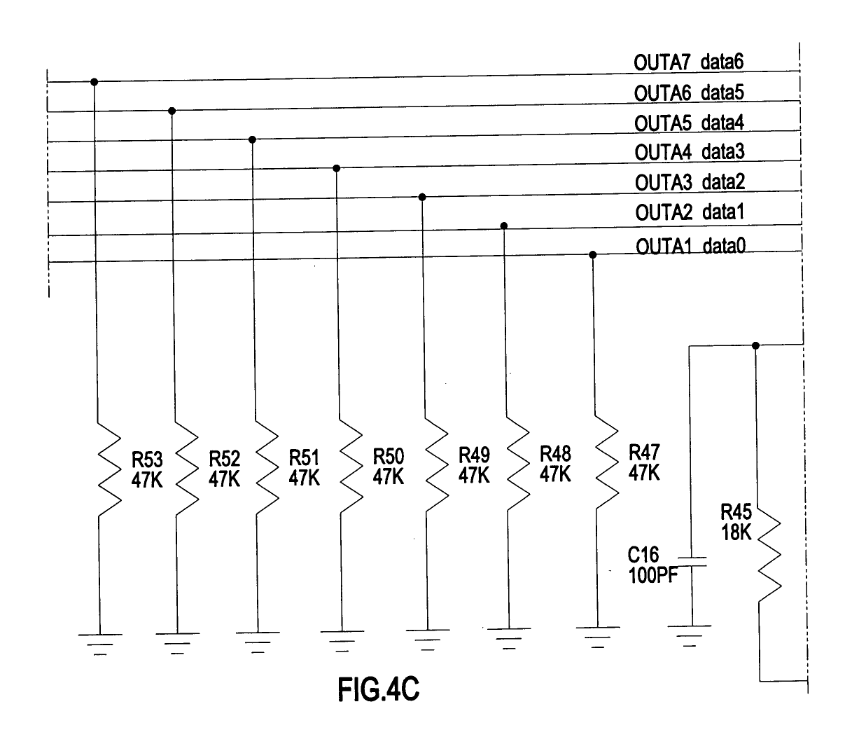

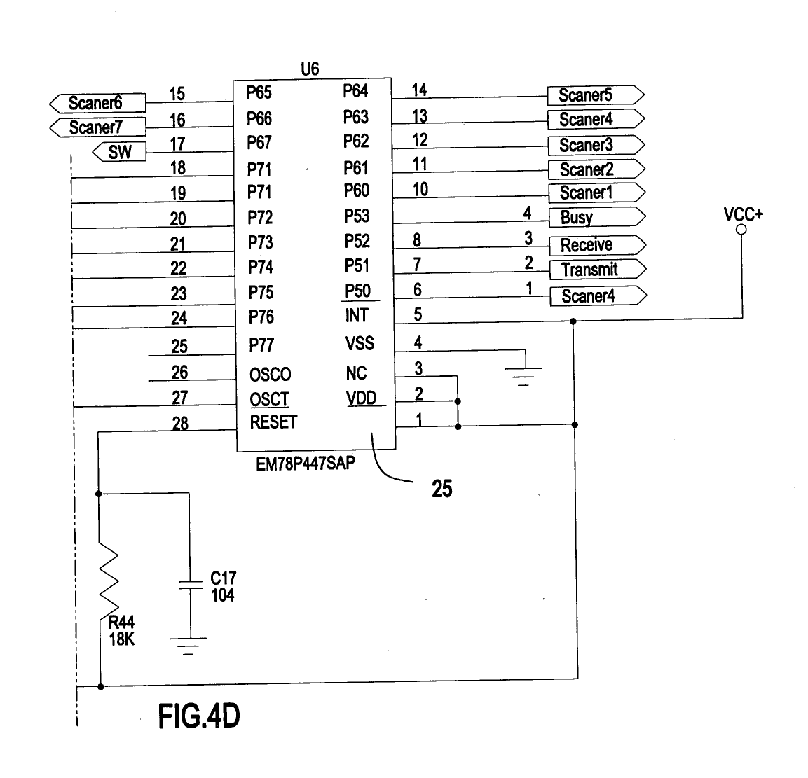

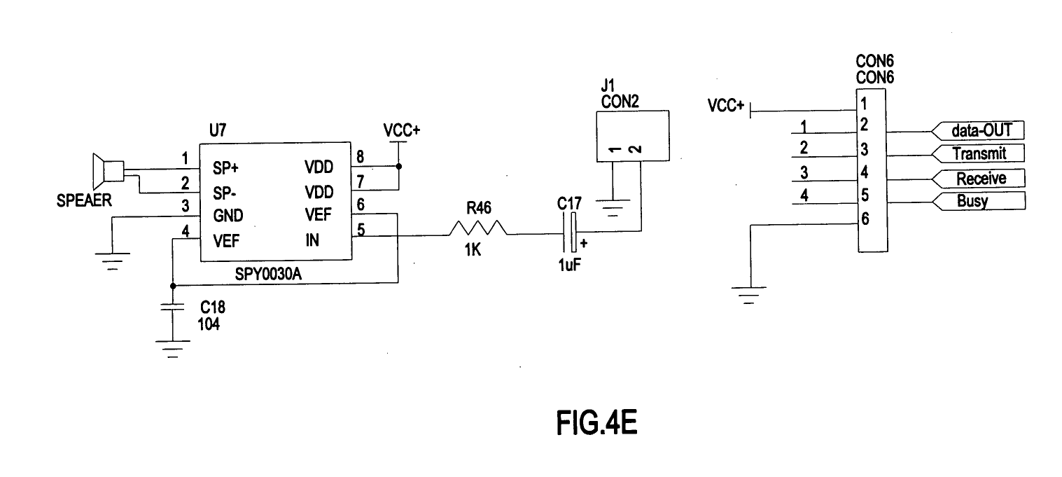

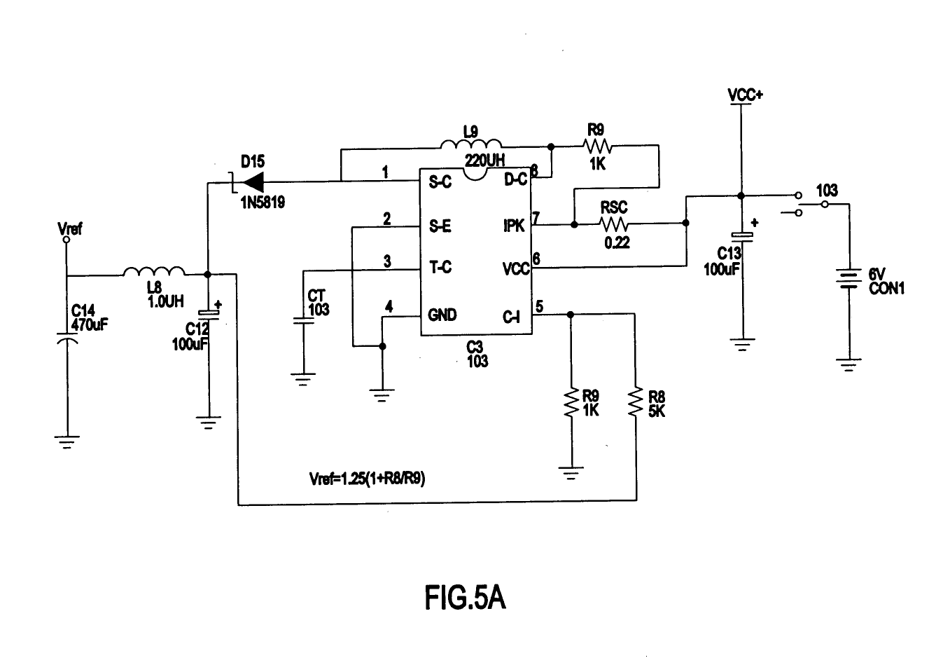

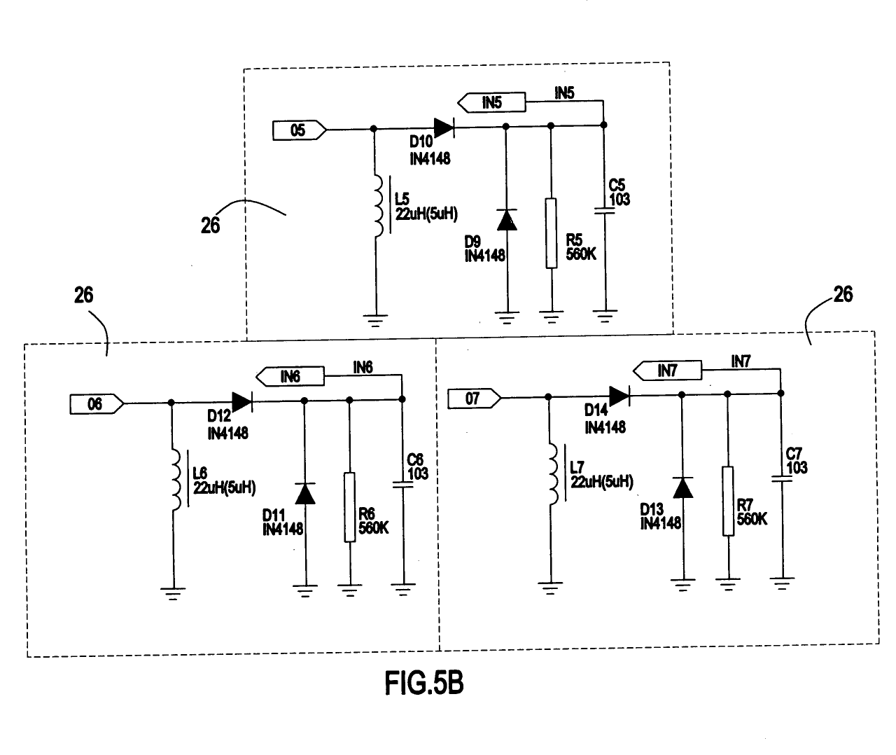

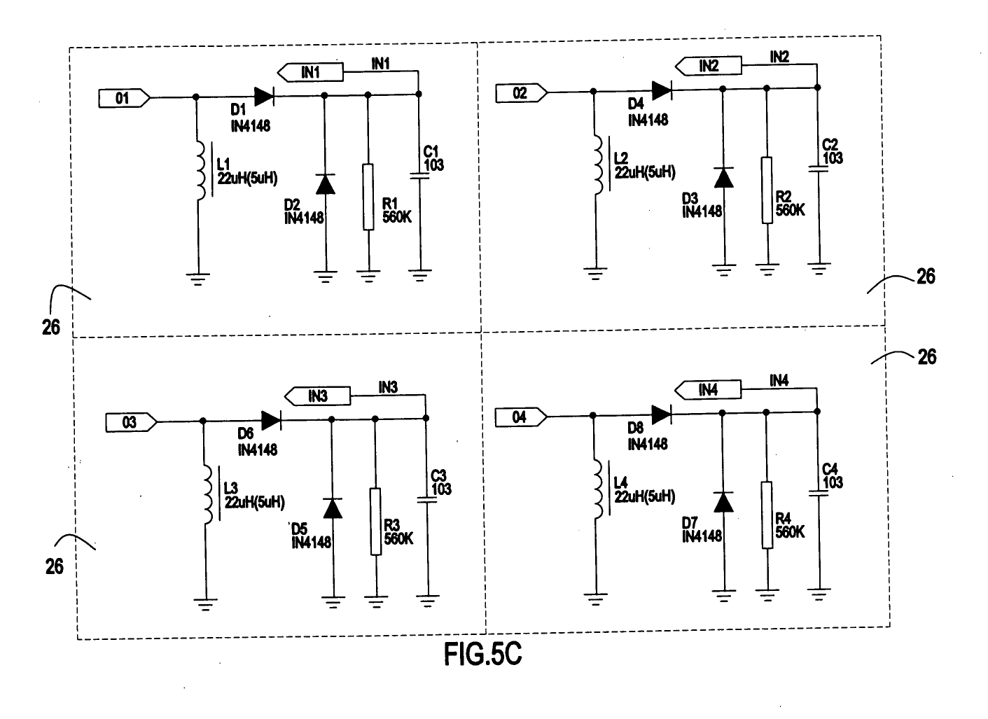

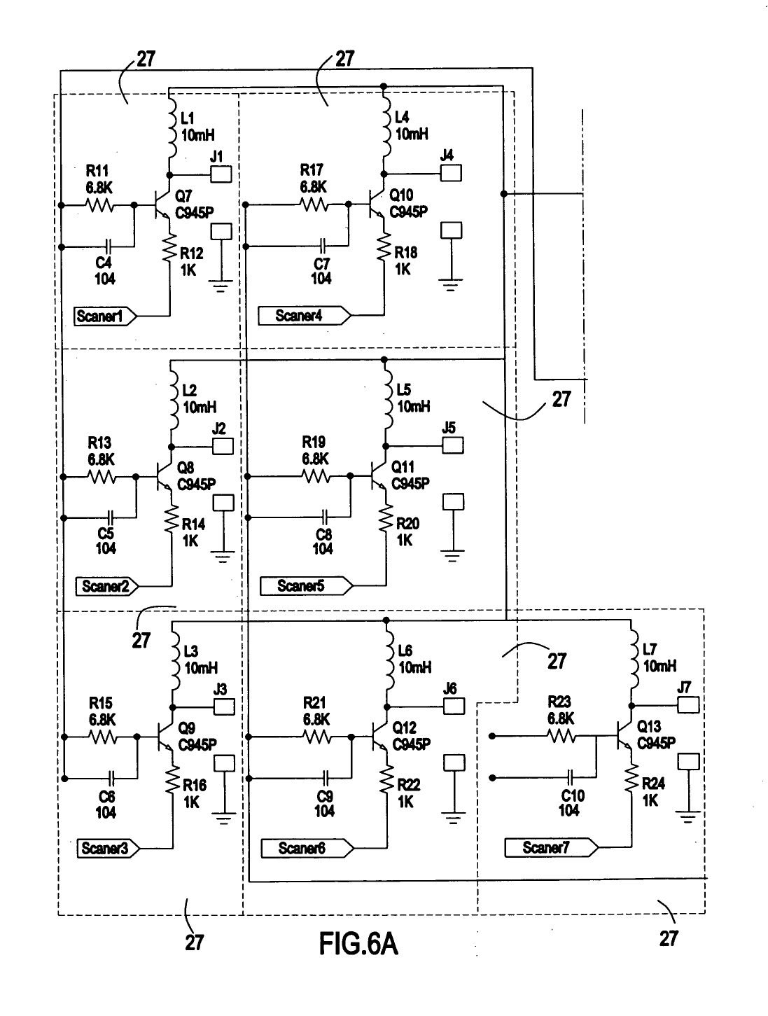

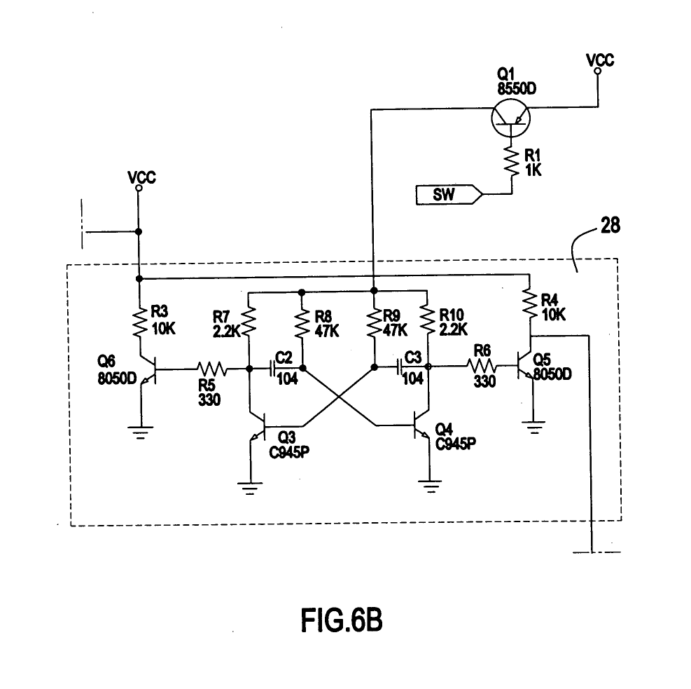

With reference to FIGS. 4-6, a circuit layout of the integrated circuit has:
a microprocessor (25), as shown in FIGS. 4A-4E, having receiving pins (data0-data6) to receive data and scanning pins (scanner1-scanner7) to output scanning signals;
a plurality of sensing modules (26), as shown in FIGS. 5A-5C, wherein each sensing module (26) has input points (01-07 in this embodiment) respectively, which is correspondingly connected to the frequency receiving points (221)-(227), wherein the first frequency receiving points (221) are connected to the first input point (01); the second frequency receiving points (222) are connected to the second input point (02), and the rest are in turn one to one correspondent. Each sensing module (26) also has an output point (IN1-IN7 in this embodiment), which is connected to the receiving pins (data0-data6) of the microprocessor (25);
a plurality of scan modules (27), as shown in FIGS. 6A-6B, and each scan module consists of transistors (Q7)-(Q13) each with a base, an emitter and a collector, wherein the bases of all the transistors (Q7)-(Q13) are controlled by an oscillating signal; the emitters of all the transistors (Q7)-(Q13) are in turn connected to the scanning pins (scanner1-scanner7) of the microprocessor respectively; and the collectors of all transistors (Q7)-(Q13) are in turn connected to the frequency emitting points (220) of the integrated circuit board (20) respectively as well as a reference voltage Vref;
*an astable multivibrator (28) composed of transistors, capacitors and resistors arranged in a symmetrical layout, to automatically generate an oscillating signal to the scan module (27).

The operation of identifying a specified card is:
when a card (40) is placed on one of the sensing slots (31), the microprocessor will in turn send a scan signal to each scan module (27) to detect which slot has the card. For instance, the scan signal will be first sent to the first scan module (27) to detect whether the card exists in the corresponding sensing slot, meanwhile, the other sensing slots are de-activated. If the card (40) exists in the first sensing slot (27), the area with carbon in the card will electronically contact some specified points of frequency receiving points (221)-(227) in the integrated circuit.

When the first sensing slot is activated by the scan signal, the scan module (27) will generate continual oscillating signals to the corresponding frequency emitting point (220). Induced by the oscillating signals, the card (40) will have electronic potentials between the carbon areas and the corresponding some of the frequency receiving points (221)-(227) contacted with those areas. On the contrary, electronic potentials cannot be detected in the areas without carbon. As the frequency receiving points (221)-(227) are connected to each sensing module (26) respectively, every specified card can be detected by the microprocessor based on electronic potential of each frequency point. Since only the first sensing slot is activated as the scan signal is only sent to the transistor Q7 in the first scan module (27), thus the statuses of other sensing slots will not be read by the microprocessor.

When the operation of the first sensing slot (31) is completed, the microprocessor (25) will send the scan signal to the transistor Q8 in the second scan module (27), meanwhile, the Q7 is de-activated, thus one by one, the statuses of all the sensing slots will be read by the microprocessor.

The data fetch has to be operated one by one, because the frequency receiving points (221)-(227) in each sensing slot are parallel connected, which means the first frequency receiving points (221) of all the sensing slots (31) are connected together, the second frequency receiving points (222) of all the sensing slot (31) are connected together, the rest are the same. Thus the data fetch occurring at the same time may disturb each other, and the correct data will not be obtained by the microprocessor.

When the data fetches of all the sensing slots are completed, the microprocessor will proceed with a calculation based on the fetched data to generate a voice signal output by a loudspeaker.

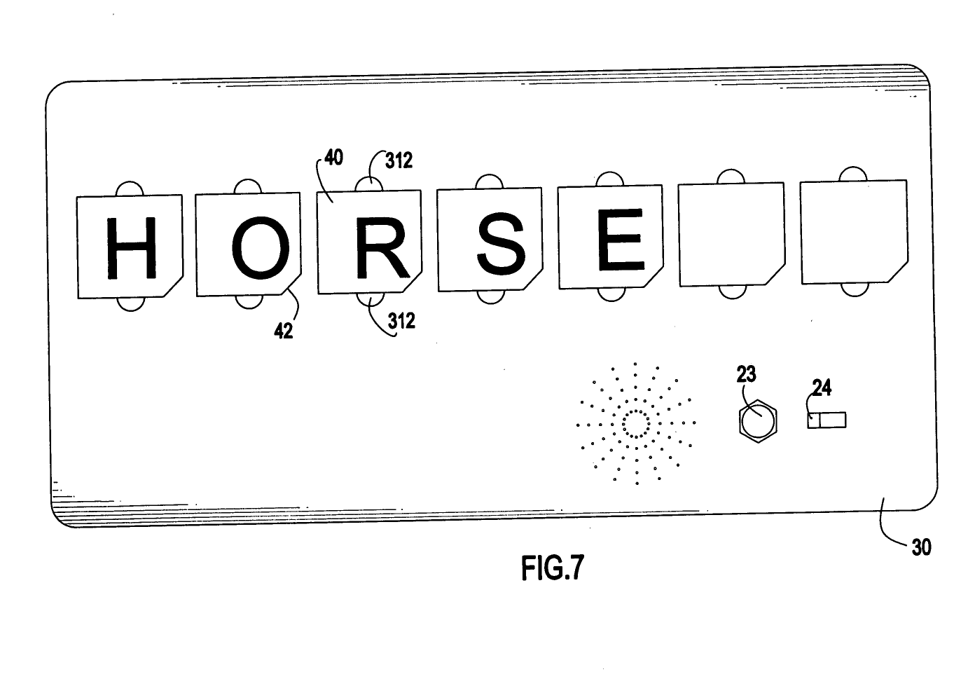

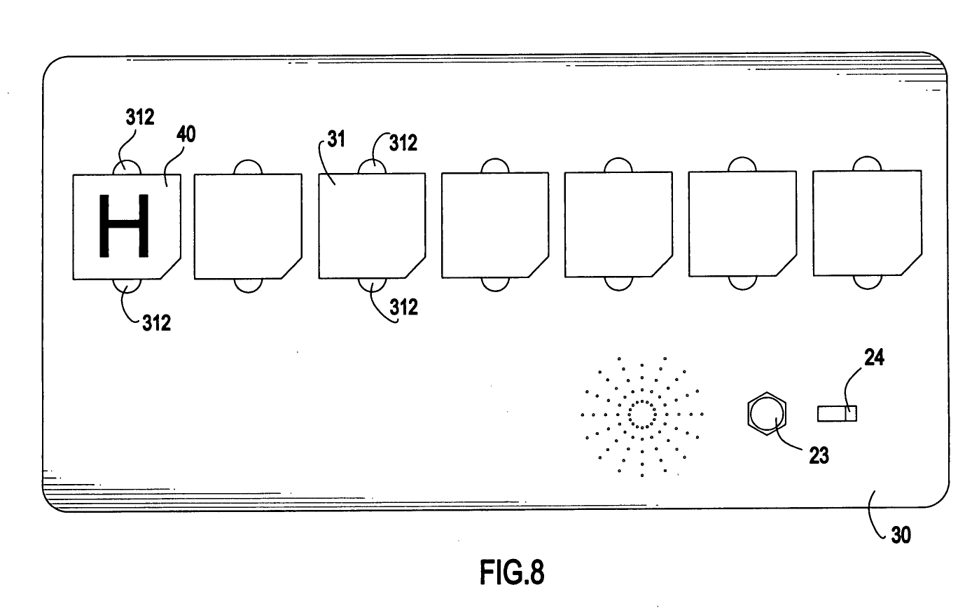

With reference to FIG. 7, when specified multiple cards are correctly placed in the sensing slots (31) to constitute a word “HORSE”, meanwhile, the letter/word switch key is switched to “word”, and every card is detected by the microprocessor to acquire their represented letter, and further detect if the card combination is correct. If the letter and combination are both correct, the pronunciation of “HORSE” will be broadcast by the speaker (21), on the contrary, the speaker will not broadcast the letter.

With reference to FIG. 8, when the letter/word switch key is switched to “letter”, only the letter recognition is activated. Since the operation of letter is substantially the same as the word operation, the explanation for the letter is omitted.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A learning machine for automatic word recognition based on a carbon pattern comprising:
a housing having a rectangular chamber to receive an integrated circuit, the integrated circuit connected with a speaker in the housing;
a panel installed on the housing, by which the integrated circuit board and other components are kept in the housing, wherein multiple sensing slots are defined through the panel, each sensing slot with an upper edge and a lower edge, so multiple cards are respectively receivable in the sensing slots, wherein one face of each card is printed with a letter while another face has a carbon pattern; whereby the integrated circuit can recognize the letter or word represented by the carbon pattern.

2. A learning machine for automatic word recognition based on a carbon pattern as defined in claim 1, wherein the integrated circuit comprises:
multiple sensing units consisting of a plurality of carbon areas, each sensing unit having a frequency emitting point and multiple frequency receiving points;
a microprocessor having multiple receiving pins to receive data and scanning pins to output scanning signals;
a plurality of sensing modules each having an input point corresponding and connected to one of the frequency receiving points, and an output point corresponding and connected to one of the receiving pins of the microprocessor;
a plurality of scan modules each consisting of a transistor with a base, an emitter and a collector, wherein the bases of all the transistors are controlled by an oscillating signal, the emitters of all the transistors are in turn connected to the scanning pins of the microprocessor; and the collectors of all transistors are connected to the frequency emitting points of each sensing unit of the integrated circuit board as well as a reference voltage; and
an astable multivibrator to generate continual oscillating signals to the transistors of the scan module.

3. A learning machine for automatic word recognition based on a carbon pattern as defined in claim 2, wherein one face of each card is divided into multiple areas being optionally printed with carbon according to the requirement.

4. A learning machine for automatic word recognition based on a carbon pattern as defined in claim 3, wherein the microprocessor is connected with a voice key and a letter/word switch key.

5. A learning machine for automatic word recognition based on a carbon pattern as defined in claim 4, wherein each sensing slot has a first chamfer.

6. A learning machine for automatic word recognition based on a carbon pattern as defined in claim 5, wherein two notches are defined in the upper edge and the lower edge of each sensing slot respectively.

7. A learning machine for automatic word recognition based on a carbon pattern as defined in claim 6, wherein a cell box is mounted in the housing to receive a battery.
